(19) United States
(12) Patent Application Publication
(10) Pub. No.: US 2010/0205123 A1
(43) Pub. Date: Aug. 12, 2010

(54) SYSTEMS AND METHODS FOR IDENTIFYING UNWANTED OR HARMFUL ELECTRONIC TEXT

(75) Inventors: D. Sculley, Summerville, MA (US); Gabriel Wachman, Brookline, MA (US); Carla E. Brokley, Summervile, MA (US)

Correspondence Address: Casimir Jones, S.C., 2275 DEMING WAY, SUITE 310, MIDDLETON, WI, 53562, US

(73) Assignee: TRUSTEES OF TUFTS COLLEGE, Boston, MA (US)

(21) Appl. No.: 12/376,970

(22) PCT Filed: Aug. 8, 2007
(86) PCT No.: PCT/US07/17808

§ 371 Date: Apr. 15, 2010

Related U.S. Application Data
(60) Provisional application No. 60/836,725, filed on Aug. 10, 2006.

(51) Int. Cl. G06F 17/30; G06F 15/18

(52) U.S. Cl. 706/12; 707/780; 707/E17.039

(57) ABSTRACT

The present invention relates to systems and methods for identifying and removing unwanted or harmful electronic text (e.g., spam). In particular, the present invention provides systems and methods utilizing inexact string matching methods and machine learning and non-learning methods for identifying and removing unwanted or harmful electronic text.

The present application claims priority to U.S. Provisional Patent Application Ser. No. 60/836,725, filed Aug. 10, 2006, which is herein incorporated by reference in its entirety.

### FIELD OF THE INVENTION

The present invention relates to systems and methods for identifying and removing unwanted or harmful electronic text (e.g., spam). In particular, the present invention provides systems and methods utilizing inexact string matching methods and machine learning and non-learning methods for identifying and removing unwanted or harmful electronic text.

### BACKGROUND

Unwanted e-mail traffic, known as spam, is a major problem in electronic communication. Spam abuses the primary benefit of e-mail—fast communication at very low cost and threatens to overwhelm the utility of this increasingly important medium. Indeed, one inside observer recently estimated that a full 90% of all e-mail in a popular Internet e-mail system is some form of spam. Left unchecked, spam can be seen as one form of a well-known security flaw: the denial of service attack.

A variety of automatic spam filters have been developed to combat this problem. These filters automatically classify an incoming e-mail as unwanted spam or desired “ham”. Based on statistical methods such as the naive Bayes rule, these filters have provided a much needed first defense against spam. However, these methods are far from perfect and may be defeated by sophisticated spammers using techniques such as tokenization and obfuscation which exploit the underlying feature representations employed by the statistical filters (e.g., a word indicative of unwanted content (e.g., ‘viagra’) is rewritten with intentional misspellings, spacings, and character substitutions (e.g., ‘viaggrra’ or ‘v ! a g r a’)) (see, e.g., G. L. Wittel and S. F. Wu. On attacking statistical spam filters. CEAS: First Conference on Email and Anti-Spam, 2004; herein incorporated by reference in its entirety). Meanwhile, the spam filtering problem is intensified by misclassification costs that are potentially very high, especially for the false positive misclassification of a needed ham as unwanted spam (see, e.g., A. Kolcz and J. Alspector. SVM-based filtering of e-mail spam with content-specific misclassification costs. In Proceedings of the TextDM'01 Workshop on Text Mining—held at the 2001 IEEE International Conference on Data Mining, 2001; herein incorporated by reference in its entirety). Mislabeling an important e-mail as spam may have serious consequences for both commercial and personal communication. What is needed are improved spam filtration techniques, as well as improved systems and methods for identifying and handling other unwanted or harmful electronic text.

### SUMMARY

The present invention provides systems and methods for identifying, removing, avoiding, or otherwise processing unwanted or harmful electronic text. The present invention is not limited by the nature of the electronic text. In some embodiments, the source of the electronic text is an electronic mail (e-mail) message, an instant message, a webpage, a digital image, or the like. However, any form of electronic text may be analyzed and/or processed, including streaming text provided over communication networks (e.g., cable television, Internet, public or private networks, satellite transmissions, etc.).

The present invention is also not limited by the nature of the unwanted or harmful text. An individual user, in some embodiments, can select criteria for defining unwanted or harmful text. In some embodiments, unwanted or harmful text is unsolicited advertising (e.g., spam), adult content, profanity, copyrighted materials, or illegal content. However, unwanted text may also be any undesired topic, words, names, or phrases that the user wishes to avoid seeing in electronic text. While the present invention is not limited to the content of the electronic texts, in some embodiments, the electronic text does not contain text pertaining to biological chemical structures such as nucleic acid or amino acid sequences.

The present invention provides enhanced systems and methods that provide more efficient and more effective identification of unwanted or harmful text as compared to prior systems and methods. One component of the systems and methods of the present invention is the use of inexact string matching algorithms to identify unwanted or harmful text. Use of such methods more effectively detect variants of unwanted or harmful text that have been designed to avoid existing screening methods. A second component of the systems and methods of the present invention is the use of machine learning methods or other non-leaning methods that permit use of rules or collected information to identify undesired electronic text.

For example, in some embodiments, the methods of the present invention are used to identify and label a source of electronic text or a portion of electronic texts as harmful and/or unwanted and to store information related to at least one aspect of the identified electronic text. In some embodiments, the method is used to allocate a score (e.g., a numerical value) associated with a particular document or portion of electronic text based on a feature of the text. In some embodiments, the scoring system is used to define a likelihood that the analyzed text is undesired text according to the user's or predefined criteria. In some embodiments, the score defines the electronic text as undesired text, likely undesired text, potentially undesired text, desired text, etc. In such embodiments, the scoring may be used to permit the systems and methods to carry out a desired action on the electronic text. Actions include, but are not limited to, deletion of the electronic text or a portion thereof, quarantine, segregation, labeling with a warning, and the like. For example, each of the different categories defined by different scores can be segregated into different file folders. For e-mail, for example, the user can than comfortably read and prioritize text defined as wanted and can comfortably delete or ignore text defined as undesired, while giving intermediate categories the appropriate attention or action desired by the user. Criteria for scoring going forward can be altered (e.g., by the user) through identification of electronic text that has been misclassified. Changes in criteria include, but are not limited to, changes in algorithms that affect the scoring and/or placement of exemplary mischaracterized text in look-up tables so that the text or similar text is not misplaced in the future.

Both machine learning and non-learning methods find use in the systems and methods of the present invention to assist in identification of unwanted electronic text and to optimize the systems over time. For example, use of non-learning methods, such as rote learning techniques and use of lookup databases find use to identify, score, and process electronic text per the systems and methods of the present invention. For example, use of non-learning methods permits the identification of unwanted or harmful text by screening a source of electronic text, or a portion thereof, against a database of items determined to be associated with unwanted or harmful text. Newly identified unwanted text may “remembered” in the future by adding information pertaining to the unwanted text in the database. Any known or future developed technique that is compatible with the systems and methods of the present invention may be used.

Use of machine learning methods provides an intelligence to the inexact string matching algorithm that permits continuous enhancement of screening capacity. This can be directed by the user to provide optimized identification of unwanted or harmful electronic text according to the user's desired content to be seen and the user's desire level of scrutiny (e.g., to maximize a desired rate of false-positive or false-negative characterization of text as being unwanted or harmful). The present invention is not limited by the nature of the machine leaning method used. Any compatible machine learning method in existence or developed in the future is contemplated.

In some embodiments, the present invention provides efficiency (e.g., speed) compared to existing systems and methods by analyzing strings or substrings of text as opposed to the entire content of a particular source of electronic text.

The present invention is not limited by the means by which the methods of the present invention are executed. In some embodiments, a processor and computer readable medium are provided that are configured to conduct one or more of: a) receive electronic text from a source of electronic text; b) run an inexact string matching algorithm, c) provide a database of feature information identified by inexact string matching algorithms, d) provide a means for conducting a computer learning and/or non-learning method, e) receive and store user defined criteria for conducting the inexact string matching algorithm and/or computer learning method, and/or f) provide reporting to a user of results of the method. One or more processors or computer readable media in one or more locations may be used. For example, the entire method may be provided in a single computer or device (e.g., desktop computer, hand-held computer, personal digital assistant, telephone, television, etc.). However, the method may be provided using multiple devices. The method may be conducted as a service made available over an electronic communication network.

Thus, in some embodiments, the present invention provides methods for identifying unwanted or harmful electronic text comprising: analyzing electronic text using an inexact string matching algorithm to identify unwanted or harmful text, if present in said electronic text, wherein said inexact string matching algorithm utilizes a database generated by machine learning method (e.g., wherein the database comprises a classification model stored in computer memory). In some embodiments, the database is generated by a non-learning method or a combination of learning and non-learning methods.

The present invention is not limited by the nature of the inexact string matching algorithm. Exemplary configurations of the inexact string matching algorithm are provided in the Detailed Description of the Invention section below. Any method now known or developed in the future may be used. In some embodiments, the inexact string matching algorithm is configured to analyze overlapping n-grams. In some embodiments, the inexact string matching algorithm is configured to analyze overlapping n-grams comprising wildcard features. In some embodiments, the wildcard features comprise fixed wildcard features. In some embodiments, the inexact string matching algorithm is configured to analyze overlapping n-grams comprising mismatch features. In some embodiments, the inexact string matching algorithm is configured to analyze overlapping n-grams comprising gappy features. In some embodiments, the inexact string matching algorithm is configured to analyze repetition within electronic text (e.g., repeated elements such as “ab” within the text “abababab”). In some embodiments, the inexact string matching algorithm is configured to analyze transpositions within electronic text (e.g., identifying “acab” as related to the text “abac”). In some embodiments, the inexact string matching algorithm is configured to analyze transformations with text (e.g., identifying “abc” as associated with the text “def”). The transformation algorithm may employ aspects of decryption algorithms. In some embodiments, the inexact string matching algorithm is configured to analyze text features located at distances from each other (e.g., identifying “abc” as associated with text “abxxxxxxc or abyy x xc”) or in any other predicable pattern or relationship. In some embodiments, the inexact string matching algorithm is configured to analyze a substring of text contained in the electronic text, wherein the substring is analyzed with and/or without gaps, wildcards, and mismatches. In some embodiments, the inexact string matching algorithm is configured to analyze a sequence of features including one or more of n-grams, wildcard features, mismatch features, gappy features, and substring features, or other features describe herein, known in the art, or develop in the future. In some embodiments, the inexact string matching algorithm is configured to analyze a combination features including two or more of n-grams, wildcard features, mismatch features, gappy features, and substring features. In some embodiments, the inexact string matching algorithm is configured to analyze a number of features or other characteristic of features found in said electronic text or a substring of said electronic text, wherein said features include, but are not limited to, n-grams, wildcard features, mismatch features, gappy features, and substring features. In some embodiments, the inexact string matching algorithm is configured to analyze features found in the electronic text or a substring of the electronic text, wherein the features include, but are not limited to, n-grams, wildcard features, mismatch features, gappy features, and substring features, and wherein the features are analyzed using a Kernel method to represent the feature implicitly. In some embodiments, any one or more of the above techniques or any other technique described herein is combined.

The present invention is not limited by the nature of the machine learning method employed. Exemplary configurations of the machine learning methods and how they are implemented with the inexact string matching algorithms are provided in the Detailed Description of the Invention section below. Any method now know or developed in the future may be used. In some embodiments, the machine learning method is a supervised learning method (e.g., employing one or more of: support vector machines, linear classifiers, Bayesian classifiers, decision trees, decision forests, boosting, neural networks, nearest neighbor analysis, and/or ensemble methods, etc.). In some embodiments, the supervised learning method is an on-line linear classifier. In some embodiments, the on-line linear classifier is perceptron algorithm with margins (PAM). In some embodiments, the machine learning method is an unsupervised learning method (e.g., employing one or more of: K-means clustering, EM clustering, hierarchical clustering, agglomerative clustering, and/or constraint-based clustering, etc.). In some embodiments, the machine learning method is a semi-supervised learning method (e.g., employing one or more of: co-training methods, self-training methods, and/or cluster-and-label methods, etc.). In some embodiments, the machine learning method is an active learning method (e.g., employing one or more of: uncertainty sampling and/or margin-based active learning, etc.). In some embodiments, the machine learning method is an anomaly detection method (e.g., employing one or more of: outlier detection, density-based anomaly detection, and/or anomaly detection using single-class classification, etc.). In some embodiments, any one or more of the above techniques or any other technique described herein is combined.

In some embodiments, the machine learning method creates and stores feature information generated by said inexact string matching algorithm in a database. In some embodiments, the feature information is simplified prior to storage (e.g., only a subset of the features stored). In some embodiments, the simplifying is conducted using a process including, but not limited to, mutual information analysis and principle component analysis. In some embodiments, the feature information is transformed prior to storage in the database. In some embodiments, the transforming is conducted using a process including, but not limited to, rank approximation, latent semantic indexing, and smoothing.

In some embodiments of the present invention, the electronic text may be edited or processed prior to or during analysis in any desired manner. In some embodiments, algorithms are provided to canonicalize text prior to application of the inexact string matching methods. The present invention is not limited to any particular method of canoncalization and contemplates any method now known or developed in the future. For example, in some embodiments, the canoncalization of a text string involves applying an algorithm the recognizes and changes incorrect “spelling” or other obfuscations. In a sense, this operates like a spell-check application, but can employ algorithms specifically designed to identify and correct common obfuscation techniques (e.g., removal of non-alpha numberic characters, truncation of all words after a defined number characters, etc.). In some embodiments, the canoncalization makes several different possible changes to a particular string or substring, wherein each of the changes is then analyzed by the inexact string matching methods.

In some embodiments, a file containing text is processed to isolate text from non-text. For example, in some embodiments, text is extracted from image files (e.g., using a character recognition algorithm or any other method now known or later developed).

The present invention also provides systems configured to carry out any of the above methods or other methods described herein.

In some embodiments, systems and methods are provided having one or more (e.g., all) of the inexact string matching algorithms and/or computer learning and/or non-learning methods described herein. In some embodiments, a user interface (software-based or hardware-based) is provided to allow the user to activate, deactivate, or weigh any one or more of the capabilities. Thus, the user can select (e.g., over time, in response to actual experience) a set of functions that are most effective at identifying and filtering unwanted or harmful electronic text specifically encountered by that user or class of users (e.g., defined by geographic location, gender, race, profession, hobby, purchase history, economic status, etc.). In some embodiments, preset optimized criteria are provided for different classes of user, which can be selected from a menu or by other means.

The present invention is not limited by timing of when the analysis occurs. In some embodiments, the methods are carried out automatically upon receiving electronic text (e.g., receiving an e-mail, opening a web page). In some embodiments, the methods are carryout out immediately prior to viewing of the electronic text by a user. In some embodiments, the methods are carried out only upon prompting by the user. In some embodiments, the methods are carried out during or immediately following decryption of encrypted text. In some embodiments, where appropriate (e.g., where detectable patters can be identified), encrypted electronic text is analyzed.

### BRIEF DESCRIPTION OF THE DRAWINGS

FIG. 1 shows a flowchart depicting off-line supervised learning methods.

FIG. 2 shows a flowchart depicting on-line supervised learning methods.

FIG. 3 shows an ROC curve for open-source statistical spam filters and selected kernels on SpamAssassin Public Corpus experiments.

FIG. 4 shows an ROC curve for TREC 2005 experiments, using open-source statistical spam filters and kernel methods.

### DEFINITIONS

To facilitate an understanding of the present invention, a number of terms and phrases are defined below:

As used herein the terms “processor,” “digital signal processor,” “DSP,” “central processing unit” or “CPU” are used interchangeably and refer to a device that is able to read a program (e.g., algorithm) and perform a set of steps according to the program.

As used herein, the term “algorithm” refers to a procedure devised to perform a function.

As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

As used herein, the terms “World Wide Web” or “Web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the terms “computer memory” and “computer memory device” refer to any storage media readable by a computer processor. Examples of computer memory include, but are not limited to; RAM, ROM, computer chips, digital video disc (DVDs), compact discs (CDs), hard disk drives (HDD), flash memory, and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, and magnetic tape.

### DETAILED DESCRIPTION

The identification of spam, the electronic equivalent of junk mail, is a major problem at both the industrial and personal levels of Internet use, and Internet service providers. Automatic spam filters are widely employed to address this issue, but current methods are far from perfect. The present invention provides systems and methods that use inexact string matching in conjunction with machine learning and/or non-learning methods to identify unwanted or harmful electronic text, such as spam email and webpages with adult or illegal content. This innovation has led to dramatic improvements in performance over prior methods. In particular, the present invention provides systems and methods for the identification of, for example, spam email, identification of spam instant messages, identification of webpages containing adult content and/or illegal content, and identification of anomalous text. While the invention is often illustrated with the example of spam, below, it should be understood that the invention is not so limited.

The problem of classifying spam has a fundamental difference from standard text classification. Both spam and standard text are produced with the goal of conveying information to an eventual reader—however, spam messages are also produced with the goal of avoiding detection. Thus, the producer of a spam message is often an adversary who seeks to defeat a spam classifier. Currently, there are several known methods of attack employed by these adversaries to defeat spam classifiers (see, e.g., G. L. Wittel and S. F. Wu. On attacking statistical spam filters. CEAS: First Conference on Email and Anti-Spain, 2004; herein incorporated by reference in its entirety). These include the techniques of tokenization, obfuscation, statistical attacks, and sparse data attacks. A robust spam filter should be flexible to resist all such attacks.

Tokenization and obfuscation are methods that attempt to make certain words unrecognizable by spam filters (see, e.g., G. L. Wittel and S. F. Wu. On attacking statistical spam filters. CEAS: First Conference on Email and Anti-Spam, 2004; herein incorporated by reference in its entirety). Tokenization attacks the idea of word boundaries by adding spaces within words with the hope that each group of characters will be mapped to new, previously unrecognized word-based features. Obfuscation includes techniques such as character substitution and insertion, again with the idea that such alternate versions will be mapped to new, previously unseen word-based features. As an example of just how prevalent such methods are in recent spam, the TREC 2005 spam corpus (see, e.g., G. V. Cormack and T. R. Lynam. Spam corpus creation for TREC. In Proceedings of the Second Conference on Email and Anti-Spam (CEAS), 2005; G. V. Cormack and T. R. Lynam. TREC 2006 spam track overview. In The Fourteenth Text Retrieval Conference (TREC 2005) Proceedings, 2005; each herein incorporated by reference in their entireties) contains several hundred unique variations of the word ‘viagra’ generated by tokenization and obfuscation, totaling thousands of instances. A robust spam classifier should be able to detect such variations automatically, without the need for rote learning.

Statistical attacks such as the “good word attack” (see, e.g., D. Lowd and C. Meek. Good word attacks on statistical spam filters. In Proceedings of the Second Conference on Email and Anti-Spam (CEAS), 2005; herein incorporated by reference in its entirety) attempt to prey upon weaknesses in a spam filter's underlying classification method. In the good word attack, the spammer includes large number of innocuous words (sometimes including long quotations of from other sources, such as literature) which has the effect of watering down the impact of very ‘spammy’ words in the message. The “sparse data attack” also targets the underlying structure of the classifier, in this case by making the spam message very short, which may keep the total ‘spamminess’ score below thresholds with some classifiers.

Current spam filtering techniques are further hindered by the danger of false-positive or misclassification of non-adversarial email as spam (see, e.g., A. Kolcz and J. Alspector. SVM-based filtering of e-mail spam with content-specific misclassification costs. In Proceedings of the TextDM'01 Workshop on Text Mining—held at the 2001 IEEE International Conference on Data Mining, 2001; herein incorporated by reference in its entirety). Mislabeling an important e-mail as spam may have serious consequences for both commercial and personal communication.

Many current spam filters are based on the naive Bayes rule from machine learning. Other machine I earning methods have also been tried, including Support Vector Machines (SVMs) (see, e.g., H. Drucker, V. Vapnik, and D. Wu. Support vector machines for spam categorization. IEEE Transactions on Neural Networks, 10(5):1048-1054, 1999; A. Kolcz and J. Alspector. SVM-based filtering of e-mail spam with content-specific misclassification costs. In Proceedings of the TextDM'01 Workshop on Text Mining—held at the 2001 IEEE International Conference on Data Mining, 2001; G. Rios and H. Zha. Exploring support vector machines and random forests for spam detection. In Proceedings of the First Conference on Email and Anti-Spam (CEAS), 2004; each herein incorporated by reference in their entireties), which yield strong performance on standard text classification problems (see, e.g., T. Joachims. Text categorization with support vector machines: Learning with many relevant features. In ECML '98: Proceedings of the 10th European Conference on Machine Learning, pages 137-142, 1998; herein incorporated by reference in its entirety). A potential drawback of previous applications of SVMs to spam is that these approaches have relied mostly on word-based features (see, e.g., H. Drucker, V. Vapnik, and D. Wu. Support vector machines for spam categorization. IEEE Transactions on Neural Networks, 10(5):1048-1054, 1999; A. Kolcz and J. Alspector. SVM-based filtering of e-mail spam with content-specific misclassification costs. In Proceedings of the TextDM'01 Workshop on Text Mining—held at the 2001 IEEE International Conference on Data Mining, 2001; each herein incorporated by reference in their entireties) which are vulnerable to attack (see, e.g., G. L. Wittel and S. F. Wu. On attacking statistical spam filters. CEAS: First Conference on Email and Anti-Spam, 2004; herein incorporated by reference in its entirety). Rios and Zha addressed some of these issues by employing a list of known word obfuscations (see, e.g., G. Rios and H. Zha. Exploring support vector machines and random forests for spam detection. In Proceedings of the First Conference on Email and Anti-Spam (CEAS), 2004; herein incorporated by reference in its entirety). However, such a method is vulnerable to new obfuscations, and generating an exhaustive list of all possible obfuscations is clearly impractical. Fortunately, SVMs are not limited to word-based features. The application of SVMs also enables the use of a variety of string matching kernels (see, e.g., H. Lodhi, et al., 2002, Journal of Machine Learning Research (2):419-444, 2002; J. Shawe-Taylor and N. Cristianini. Kernel Methods for Pattern Analysis. Cambridge University Press, 2004; each herein incorporated by reference in their entireties), such as wildcard kernels, which are capable of recognizing inexact matches between strings. These kernels have been applied in computational biology for classification of genome data (see, e.g., C. Leslie, E. Eskin, and W. S. Noble, 2002, Proceedings of the Pacific Symposium on Biocomputing, January, pp. 564-575; C. Leslie, et al., 2003, Neural Information Processing Systems, (15):1441-1448, 2003; C. Leslie and R. Kuang. Fast kernels for inexact string matching. Conference on Learning Theory and Kernel Workshop, pages 114-128, 2003; C. Leslie and R. Kuang, 2004, Journal of Machine Learning Research, (5):1435-1455, 2004; each herein incorporated by reference in their entireties), because they are able to detect similarities among various genomes despite character substitutions caused by mutation.

The present invention provides improved systems and methods for detecting and classifying spam through use of inexact string matching methods.

Inexact string matching methods allow the user to detect the similarity between words such as ‘viagra’, ‘viaggrra’, and ‘v ! a g r a’, and are thus far more resistant to such attacks. Inexact string matching used in conjunction with machine learning techniques creates powerful classifiers which significantly out-perform previous methods for identifying unwanted electronic text. In experiments conducted during the course of the present invention, the systems and methods of the present invention reduced the false positive rate of spam email identification to as little as 2.7% of the false-positive rate of current spam filtering technology.

There are a variety of inexact string matching methods that may be applied to the problem of identifying unwanted or harmful electronic text. Inexact string matching methods used in the systems and methods of the present invention include, but are not limited to, wildcard methods, mismatch methods, gappy methods, substring methods, transducer methods, repetition detection methods, transposition detection methods, transformation detection methods, at-a-distance assessment methods, hidden markov methods, or any other method now known or developed in the future, as well as combinations of these methods. These methods may be used, for example, to create explicit feature representations of the electronic text, or to perform implicit mappings for greater efficiency with certain machine learning methods. The inexact string matching methods may be used in conjunction with any machine learning method, including, but not limited to, supervised learning, unsupervised learning, semi-supervised learning, active learning, and anomaly detection.

In some embodiments, the systems and methods utilize a supervised learning framework. The present invention is not limited to utilization of a particular type or kind of supervised learning framework. In some embodiments, the supervised learning framework uses a model to determine whether or not a given piece of electronic text is unwanted or harmful. The electronic text is represented by, for example, features which are generated (either explicitly or implicitly) by the inexact string matching methods. The model may be learned using either online-supervised learning methods, or off-line supervised machine learning methods. On-line and off-line learning methods may be combined in any fashion.

The present invention is not limited by the nature of the model used or the nature in which the model is stored or accessed. In some embodiments, databases are used to store models, look-up tables of stored electronic text, or any other information useful in carrying out the methods of the present invention, in computer memory.

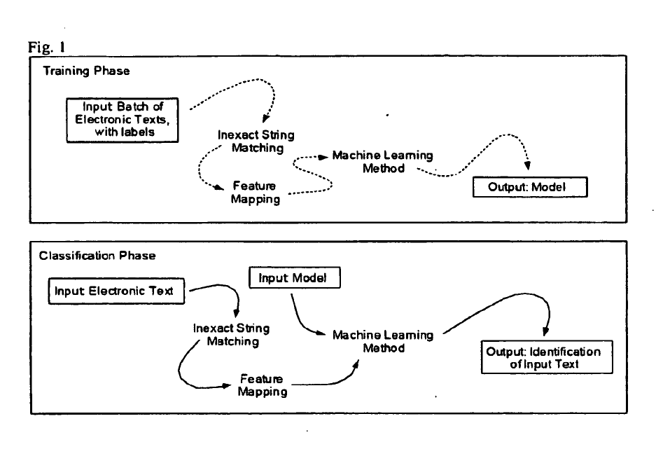

In off-line supervised machine learning (see, FIG. 1), there are, for example, training and classification phases. The present invention is not limited to particular specific types or kinds of training phases or classification phases. In some embodiments, within the training phase, the model is learned from an input batch of electronic texts, each of which is labeled as “unwanted/harmful” or “not unwanted/harmful.” The labels may be provided by any trusted source, such as human labeling, user feedback, or another automatic system. The labeled texts are converted into sets of features (called ‘training examples’) using the inexact string matching methods, and the training examples are then used by the machine learning method to create a model representing the nature of unwanted/harmful text. In the classification phase, each new piece of electronic text is converted into a set of features using the inexact string matching methods. The machine learning method then uses its model from the training phase to identify the text as unwanted/harmful or not.

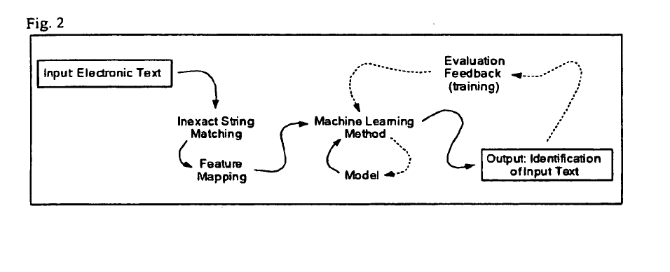

In on-line supervised machine learning (see, FIG. 2), the method begins with a model generated either by an online or offline training phase. Each new piece of electronic text is converted to features using the inexact string matching methods, and then classified by the machine learning method using the current model. However, after classification, the method may receive feedback from some trusted source (e.g., such as user feedback or human labeling). If the feedback disagrees with the classification, then the machine learning algorithm updates the model accordingly.

The present invention is not limited to a particular inexact string matching method. In some embodiments, the systems and methods of the present invention utilize one inexact string matching method. In some methods, the systems and methods of the present invention utilize two or more inexact string matching methods. Indeed, the present invention contemplates the use of a variety of inexact string matching methods, either singly or in combination, to create features either explicitly or implicitly. In some embodiments, features are used explicitly, for example, in the generation of a database storing the feature information. In some embodiments, features are used implicitly, for example, by storing databases of examples of electronic text identified by the methods of the present invention (i.e., which implicitly contain the feature(s)), possibly with an associated weight score.

Features represent coordinates in a space. F^{d} represents the feature space F with d dimensions. Converting an electronic text into features represents the text as, for example, a point in the feature space. This may be done either by score based methods, which assign a real valued score to each feature based on the number of times the feature's index occurs in the text, in binary form, where each feature is given a binary 1/0 score denoting that the feature's index did or did not occur in the text, or by any other desired method.

The systems and methods of one implementation of the present invention convert electronic text into features with a binary scoring method. Previous methods for spam detection and classification employ a feature space indexed by the set of possible words. However, this feature representation is not expressive enough to combat intentional obfuscations and other methods of defeating prior methods. The present invention provides systems and methods of representing electronic text with sophisticated features that address the problems of, for example, word obfuscations.

In some embodiments, the inexact string matching methods include wildcard kernels. The present invention is not limited to use of particular wildcard kernels. In some embodiments, the wildcard kernels utilized in the present invention include inexact string matching kernels, which have seen use in the field of computational biology for work with genomic data. Other kernels in this area include the spectrum (or n-gram, or k-mer) kernel (see, e.g., C. Leslie, E. Eskin, and W. S. Noble. The spectrum kernel: A string kernel for svm protein classification. Proceedings of the Pacific Symposium on Biocomputing, pages 564-575, January 2002; herein incorporated by reference in its entirety), the mismatch kernel (see, e.g., C. Leslie, et al., 2003, Neural Information Processing Systems (15):1441-1448; herein incorporated by reference in its entirety) and the gappy kernel (see, e.g., C. Leslie and R. Kuang, 2004, Journal of Machine Learning Research, (5):1435-1455; herein incorporated by reference in their entireties). Additional kernels contemplated for use in the systems and methods of the present invention are described in, for example, J. Shawe-Taylor and N. Cristianini, Kernel Methods for Pattern Analysis, Cambridge University Press, 2004, which is herein incorporated by reference in its entirety.

In some embodiments, the inexact string matching methods include spectrum (n-gram) kernels. The spectrum (n-gram) kernel maps strings into a feature space using overlapping n-grams, which are contiguous substrings of n symbols (see, e.g., H. Lodhi, et al., 2002, Journal of Machine Learning Research, (2):419-444; C. Leslie, E. Eskin, and W. S. Noble. The spectrum kernel: A string kernel for svm protein classification. Proceedings of the Pacific Symposium on Biocomputing, pages 564-575, January 2002; each herein incorporated by reference in their entireties). For example, the 3-grams of the string ababb are: aba bab abb. For example, the 3-grams of the text ‘bad mail’ are ‘bad’, ‘ad_’, ‘d_m’, ‘_ma’, ‘mai’, and ‘ail’. The spectrum kernel's feature space is indexed by unique n-grams; thus, the dimensionality of this space is |Σ|ⁿ, where |Σ| is the size of the alphabet of available symbols, and the value of each dimension in the space corresponds to the score associated with a particular n-gram. Features are commonly scored by counting the number of times a given n-gram appears in the string; Leslie et al. also note the possibility of a binary 0, 1 scoring method indicating presence or absence of an n-gram in the string (see, e.g., C. Leslie, E. Eskin, and W. S. Noble. The spectrum kernel: A string kernel for svm protein classification. Proceedings of the Pacific Symposium on Biocomputing, pages 564-575, January 2002; herein incorporated by reference in its entirety). In e-mail and spam classification tasks, which may include attachments, the available alphabet of symbols is quite large, consisting of all 256 possible single-byte characters. Unlike the bag-of-words model, which loses all sequence information, the overlapping n-grams do capture some localized sequence information by crossing over word boundaries and the like. Because vectors in this feature space are usually sparse, it is possible to evaluate the kernel without indexing all the |Σ|^{N} features. Sparse vector techniques naively address this issue, but more efficient methods of evaluating these kernels are available using suffix trees (see, e.g., C. Leslie, E. Eskin, and W. S. Noble. The spectrum kernel: A string kernel for svm protein classification. Proceedings of the Pacific Symposium on Biocomputing, pages 564-575, January 2002; herein incorporated by reference in its entirety) or trie data structures (see, e.g., C. Leslie, et al., 2003, Neural Information Processing Systems, (15):1441-1448; herein incorporated by reference in its entirety).

In some embodiments, the inexact string matching algorithm is configured to analyze repetition within electronic text (e.g., repeated elements such as “ab” within the text “abababab”). In some embodiments, the inexact strong matching algorithm is configured to analyze transpositions within electronic text (e.g., identifying “acab” as related to the text “abac”). In some embodiments, the inexact string matching algorithm is configured to analyze transformations with text (e.g., identifying “abc” as associated with the text “def”). The transformation algorithm may employ aspects of decryption algorithms. In some embodiments, the inexact string matching algorithm is configured to analyze text features located at distances from each other (e.g., identifying “abc” as associated with text “abxxxxxxc or abyy x xc”) or in any other predicable pattern or relationship.

In some embodiments, the inexact string matching methods include wildcard kernels. The wildcard kernel extends the available symbol alphabet E with a special character, represented as *. A (n,m) wildcard kernel allows n-grams to match if they are equivalent when up to m characters have been replaced by *. The kernel described by Leslie and Kuang allows * to match any other symbol (see, e.g., C. Leslie and R. Kuang, 2004, Journal of Machine Learning Research, (5):1435-1455; herein incorporated by reference in its entirety), but only allows the m wildcards to appear in one of the two sub-strings. In some embodiments, the equivalent variant applied only allows * to match with itself, but allows m wildcards to appear in each of the two sub-strings.

A wildcard kernel can be seen as populating a wildcard space near the ordinary n-grams. To illustrate, a (3, 1) wildcard kernel will map the string ababb to the features indexed by:

| | | |
|---|---|---|
| aba | bab | abb |
| *ba | *ab | a*b |
| a*a | b*b | *bb |
| ab* | ba* | |

Wildcard features augment an n-gram feature space by allowing a given number of characters in the n-gram to be replaced by wildcard symbols, which match any character. An (n,m) wildcard feature representation includes all possible n grams with up to m wildcard symbols. As an additional example, the (3,1) wildcard features of ‘bad mail’ are ‘bad’, ‘b*d’, ‘ad_’, ‘*d_’, ‘a*_’, ‘ad*’, ‘d_m’, ‘*_m’, ‘d*m’, ‘d_*’, ‘_ma’, ‘*ma’, ‘_*a’, ‘_m*’, ‘mai’, ‘*ai’, ‘ma*’, ‘ail’, ‘a*1 ’, and ‘ai*’.

Wildcard kernels, like spectrum kernels, involve sparse vector spaces. A variety of feature scoring methods are available. In some embodiments, the present invention applies both scoring by count and binary scoring for features in the wildcard space in testing. In experiments conducted during the course of the present invention, it was found that binary scoring is superior for spam classification (e.g., binary scoring provides resistance to the good word attack).

In some embodiments, the inexact string matching methods include fixed wildcard features. A restricted form of wildcard features allows wildcard symbols to replace characters in an n-gram sequence only at a given position. An (n; m1, m2 . . . mq) fixed wildcard feature representation allows wildcards to be placed only at positions m1, m2, thought mq, with position count starting at 0. Thus, the (3;1) fixed wildcard features if ‘bad mail’ are ‘bad’, ‘b*d’, ‘ad_’, ‘a*_’, ‘d_m’, ‘d*m’, ‘_ma’, ‘_*a’, ‘mai’, ‘m*i’, ‘ail’, and ‘a*l’.

The fixed (n, p) wildcard kernel is similar to the regular (n,m) wildcard kernel, except that this fixed variant allows, for example, only a single wildcard substitution in the n-gram, which occurs at position p (e.g., following standard array notation, the first position in an n-gram is position 0.) As with other kernels, features can be scored both by counting and by binary methods, or by any other desired method.

The fixed (3, 1) wildcard mapping of the example string ababb produces the features:

aba bab abb
b*b a*b

The fixed wildcard kernel is thus a compromise between the full expressivity of the standard (n,m) wildcard kernel, and the strict matching required by the spectrum kernel.

In some embodiments, the inexact string matching methods include mismatch features. Mismatch features allow for character substitution within n-grams. For example, finding the 3-gram ‘bad’ in a piece of electronic text would generate not only the feature for ‘bad’, but also mismatch features with character substitutions such as ‘cad’, ‘dad’, ‘ead’, ‘ban’, and so forth. In some embodiments, a substitution cost is associated with each possible substitution. For example, in some embodiments, it costs less to substitute ‘m’ for ‘n’ than ‘5 ’ for T. Mismatch features may be specified by length of n-gram, along with total number of substitutions or total cost allowed.

In some embodiments, the inexact string matching methods include gappy features. Gappy features allow for n-grams to be found in electronic text by skipping over characters in the text. For example, the 3-gram ‘barn’ does not occur in the text ‘bad mail’, but ‘barn’ does occur as a gappy 3-gram, by skipping over the characters ‘d’ and space.

In some embodiments, the inexact string matching methods include substring features. Features need not be limited to a fixed size, as with n-grams. Instead, all possible strings (that is, character sequences of any length) may be used as features. Substrings may be found with or without gaps, wildcards, and mismatches.

In some embodiments, the inexact string matching methods include subsequences of features. Sequences need not be limited to sequences of characters, and may include sequences or combinations of other features, such as n-grams, wildcard features, mismatch features, gappy features, and substring features.

In some embodiments, the inexact string matching methods include features of features. Other features may be produced, which denote logical combinations of features or other functions on features and feature values. For example, there may be a feature denoting that exactly one of two given features occurred in the text.

In some embodiments, the inexact string matching methods include combinations. Any of the methods above may be used in combination or conjunction with each other, and with prior feature methods such as word based features. This allows for such things as word based features with wildcards, mismatches, and gaps.

In some embodiments, the inexact string matching methods include implicit features. Kernel methods may be used to represent the features implicitly, rather than explicitly. With implicit feature mappings, the inner product of feature vectors may be computed without explicitly computing the value of each needed feature. This is especially useful when using features of features. Techniques for this include inexact string matching kernels using dynamic programming, inexact string matching kernels using tries, and inexact string matching kernels using suffix trees. Implicit feature mapping only changes the computational efficiency of the features—the actual nature of the features remains the same.

The number of features used by a given machine learning method may be reduced through the use of a feature selection method. Methods for feature selection include feature selection using mutual information, principle component analysis, and other methods.

Features may be transformed before being used by the machine learning method. Methods for transformation include reduced rank approximation, latent semantic indexing, smoothing, and other methods.

The present invention is not limited to a particular type of machine learning methods. The method of identifying unwanted or harmful electronic text using inexact string matching methods may be performed with any machine learning method, including, but not limited to, supervised learning methods, unsupervised learning methods, semi-supervised learning methods, active learning methods, and anomaly detection methods. In some embodiments, the systems and methods of the present invention utilize a supervised learning framework with support vector machines. In some embodiments, machine learning methods may be used in combination.

The present invention is not limited to a particular supervised learning method. Any supervised learning method may be used with the features from the inexact string matching methods, including, but not limited to the following methods and their variants: support vector machines, linear classifiers (e.g., perceptron (e.g., perceptron algorithm with margins), winnow, etc.), bayesian classifiers, decision trees, decision forest, boosting, neural networks, nearest neighbor, and ensemble methods.

The present invention is not limited to a particular type of support vector machine. Support vector machines are important tools in modern data mining, and are of particular utility in the area of text classification (see, e.g., C. J. C. Burges, 1998, Data Mining and KnowledgeDiscovery, 2(2):121-167; N. Christianini and J. Shawe-Taylor. An Introduction to Support Vector Machines and Other Kernel-based Learning Methods. Cambridge University Press, New York, N.Y., 2000; J. Shawe-Taylor and N. Cristianini. Kernel Methods for Pattern Analysis. Cambridge University Press, 2004; each herein incorporated by reference in their entireties). Support vector machines were first introduced for text classification (see, e.g., T. Joachims. Text categorization with support vector machines: Learning with many relevant features. In ECML '98: Proceedings of the 10th European Conference on Machine Learning, pages 137-142, 1998; herein incorporated by reference in its entirety) due to their strength at dealing with large numbers of both relevant and irrelevant features, such as features extracted from the words in text. Since then, SVMs have been used to classify spam by at least three researchers: two using only word-based features (see, e.g., H. Drucker, V. Vapnik, and D. Wu. Support vector machines for spam categorization. IEEE Transactions on Neural Networks, 10(5):1048-1054, 1999; A. Kolcz and J. Alspector. SVM-based filtering of e-mail spam with content-specific misclassification costs. In Proceedings of the TextDM'01 Workshop on Text Mining—held at the 2001 IEEE International Conference on Data Mining, 2001; each herein incorporated by reference in their entireties), one using word-based features and a set of known word obfuscations (see, e.g., G. Rios and H. Zha. Exploring support vector machines and random forests for spam detection. In Proceedings of the First Conference on Email and Anti-Spam (CEAS), 2004; herein incorporated by reference in its entirety).

In some embodiments, the systems of the present invention utilize perceptron algorithm with margins (PAM) classifier (see, e.g., Krauth and Mezard; 1987 Journal of Physics A, 20(11):745-752; Li, et al., The perceptrom algorithm with uneven margins. In International Conference on Machine Learning, pages 379-386, 2002; each herein incorporated by reference in their entireties) as a supervised learning method, which learns a linear classifier with tolerance for noise (see, e.g., Khardon and Wachman. Noise tolerant variants of the perceptron algorithm. Technical report, Tufts University, 2005. in press, Journal of Machine Learning Research; herein incorporated by reference in its entirety).

The perceptron algorithm (see, e.g., Rosenblatt, Psychological Review, 65:386-407, 1958; herein incorporated by reference in its entirety) takes as input a set of training examples in [symbol] with labels in {−1, 1}. Using a weight vector, wε [symbol] , initialized to 0ⁿ, it predicts the label of each training example x to be y=sign( [symbol] w, x [symbol] ). The algorithm adjusts w on each misclassified example by an additive factor. An upper-bound on the number of mistakes committed by the perceptron algorithm can be shown both when the data are linearly separable (see, e.g., Novikoff. On convergence proofs on perceptrons. Symposium on the Mathematical Theory of Automata, 12:615-622, 1962; herein incorporated by reference in its entirety) and when they are not linearly separable (see, e.g., Freund and R. Schapire. Machine Learning, 37:277-296, 1999; herein incorporated by reference in its entirety).

The Perceptron Algorithm with Margins (PAM) (see, e.g., Krauth and Mezard, Journal of Physics A, 20(11):745-752, 1987; Li, et al., The perceptrom algorithm with uneven margins. In International Conference on Machine Learning, pages 379-386, 2002; each herein incorporated by reference in their entireties) establish a data separation margin, τ|, during the training process. To establish the margin, instead of only updating on examples for which the classifier makes a mistake, PAM also updates on xⱼ if yⱼ((xⱼ,w))<τ|. When the data are linearly separable, the margin of the classifier produced by PAM can be lower-bounded (see, e.g., Krauth and Mezard, Journal of Physics A, 20(11):745-752, 1987; Li, et al., The perceptrom algorithm with uneven margins. In International Conference on Machine Learning, pages 379-386, 2002; each herein incorporated by reference in their entireties). The algorithm is summarized in Table 1.

GIVEN: SET OF EXAMPLES AND THEIR LABELS
Z = ((x₁,y₁),... ,(xₘ,yₘ)) ∈( [symbol] × {−1,1})^{m}, τ
INITIALIZE w := 0ⁿ
FOR EVERY (xⱼ,yⱼ) ∈Z DO:

IF yⱼ((w,xⱼ)) < τ

w := w + ηyⱼxⱼ

DONE

It is important to select a reasonable value for τ|. If τ| is too large, the algorithm will not be able to find a stable hypothesis until the norm of w| grows large enough at which point individual updates will have little effect; if w| is too small, the margin of the hypothesis will be small and the performance may suffer.

The learning rate, η, controls the extent to which w| changes on a single update; too large of a value causes the algorithm to make large fluctuations, and too small of a value results in slow convergence to a stable hypothesis and hence many mistakes. Note that η can be eliminated in this case by scaling

$${{τ \vert}_{by} \frac{1}{η} \vert}_{\cdot }$$

PAM enables fast classification and on-line training. The classification time of PAM is dominated by the computation of the inner product [symbol] w,x [symbol] . A naive inner product takes) O(m)| time, where m is the number of features. When x is sparse, containing only s [symbol] m| on-zero features, this inner product can be computed in O(s) time. Similarly, the time for an on-line update is dominated by updating the hypothesis vector w, which can be done in O(s) time as well. Moreover, PAM does not require training updates for well-classified examples. Thus, the total number of updates is likely to be significantly less than the total number of training examples.

In comparison with Naive Bayes and linear support vector machines, PAM has the same classification cost O(m)|, but will have lower overall training time than either method. Naive Bayes requires O(m)|-cost updates on every example in the training set, while PAM does not train on well classified examples.

The present invention is not limited to a particular unsupervised learning method. Any unsupervised learning method may be used with the features from the inexact string matching methods, including, but not limited to, the following unsupervised learning methods and their variants: K-means clustering, EM clustering, hierarchical clustering, agglomerative clustering, and constraint-based clustering.

The present invention is not limited to a particular semi-supervised learning method. Any semi-supervised learning method may be used with the features from the inexact string matching methods, including, but not limited to, the following methods and their variants co-training, self-training, and Cluster-and-label methods.

The present invention is not limited to a particular active learning method. Any active learning method may be used with the features from the inexact string matching methods, including, but not limited to, the following methods and their variants: uncertainty sampling, and margin-based active learning.

The present invention is not limited to a particular anomaly detection methods. Any anomaly detection method may be used with the features from the inexact string matching methods, including but not limited to, the following methods and their variants: outlier detection, density-based anomaly detection, anomaly detection using single-class classification.

### EXPERIMENTAL

### Example I

This example describes use of the systems and methods of the present invention in comparison to currently available techniques. Spam filtering is a practical task, not a theoretical one. Thus, the benefit of different approaches to spam filtering may only be determined by experiment. Three kernels were tested: the wildcard kernel, the fixed wildcard kernel, and, as a baseline, the spectrum kernel. Each kernel was tested with both counting and binary feature scoring methods, and was applied in conjunction with the RBF kernel. For comparison, identical tests were run with the most recent versions of three open-source statistical spam filters, SpamAssassin version 3.1.0 (http:// followed by spamassassin.apache.org/index.html), SpamProbe version 1.4b (http:// followed by spamprobe.sourceforge.net/) and Bogofilter version 1.0.1 (http:// followed by bogofilter.sourceforge.net/).

There were three phases to the set of experiments. First, parameter tuning was performed on an independent spam data set, the ling-spam data (see, e.g., I. Androutsopoulos, J. Koutsias, K. V. Chandrinos, G. Paliouras, and C. D. Spyropoulos. An evaluation of naive bayesian anti-spam filtering. In Proceedings of Workshop on Machine Learning in the New Information Age, 11th European Conference on Machine Learning, 2000; herein incorporated by reference in its entirety), to avoid tuning to the test data. Second, a set of ten-fold cross validation experiments was run with each spam classifier on the SpamAssassin data set. Finally, to make sure that the strong results shown on the SpamAssassin data were not due simply to chance or multiple hypothesis testing, the results were confirmed with experiments on fifteen independent test/train splits drawn from the large TREC 2005 spam data set (see, e.g., G. V. Cormack and T. R. Lynam. Spam corpus creation for TREC. In Proceedings of the Second Conference on Email and Anti-Spam (CEAS), 2005; herein incorporated by reference in its entirety).

In evaluating the methods, accuracy is a flawed metric in spam filtering, due to the high cost of misclassifying good ‘ham’ e-mail (see, e.g., G. V. Cormack and T. R. Lynam. On-line supervised spam filter evaluation. Technical report, David R. Cheriton School of Computer Science, University of Waterloo, Canada, February 2006; herein incorporated by reference in its entirety). Following this lead, precision was evaluated at specific, high recall rates. Also in keeping with previous literature on spam filter evaluation, the area above the receiver operating characteristics (ROC) curve was reported (see, e.g., G. V. Cormack and T. R. Lynam. TREC 2006 spam track overview. In The Fourteenth Text REtrieval Conference (TREC 2005) Proceedings, 2005; herein incorporated by reference in its entirety). For precision and recall, the optimum value is 1, while for area above the ROC curve, the ideal value is 0.

In this context, precision answers the question, “When we say a message is spam, how often are we right?” while recall tells “Of all the spam in the data, how much did we correctly identify?” These two measures are, in practice, inversely related: one can achieve higher levels of precision by setting higher confidence requirements for decision thresholds, which has the effect of reducing recall. Because the optimum placement of the confidence threshold is dependent on the misclassification costs—which may vary by user need and preference—results for precision at several recall levels were reported. Additionally, area above the ROC curve was reported, which plots true positive rate against false positive rate, determined by varying the decision threshold. Thus, area above the ROC curve is a useful metric for evaluating classifiers when actual misclassification costs are user dependent.

Three open-source spam filters were downloaded and installed: BogoFilter, SpamProbe, and SpamAssassin. For completeness, the training and testing option used for each are described.

To train BogoFilter on a message, bogofilter -n -[sn] was run, and to test on a message, bogofilter was run. Likewise to train SpamProbe, spamprobe train-good|train-bad was run, and to test spamprobe score was run. Finally, for SpamAssassin sa-learn-ham|-spam to train was run, and spamassassin to test.

After each testing run of each filter, any files created and saved during the previous training run was manually removed. SpamAssassin does not have an effective option to turn off learning during testing. Therefore, in these tests, SpamAssassin had the benefit of learning during testing, in addition to learning during training, and the reported results include this advantage.

The support vector machine code used was SVM^{light}. The kernels were implemented with sparse vector structures, combined with built-in RBF kernel. The RBF kernel parameter was tuned as described below.

The RBF kernel was chosen to be used as it can be tuned to map across a wide range of implicit feature spaces. As noted above, the RBF kernel converges to the linear kernel with small values of γ, while with larger values it creates a mapping to a feature space of potentially infinite dimensionality and allows non-linear relationships to be found by the linear SVM (see, e.g., S. S. Keerthi and C.-J. Lin, 2003, NeuralComput., 15(7):1667-1689; herein incorporated by reference in its entirety). Tuning γ thus encompassed a wide range of possible feature spaces including that of the linear kernel.

γ was tuned to optimize the performance of the straight n-gram kernel, to provide the fairest possible test for improvement by the wildcard variants. Tuning was done by setting up a five-fold cross validation set of the ling-spam data set, using the ‘bare’ data without preprocessing. The total data set included roughly 2800 messages, with about a 14% spam rate. The data set was constructed in the year 2000.

To tune the RBF parameter γ, a coarse grained set of tests was performed, beginning with values of 2⁻¹⁵, and doubling through 2³. To avoid over-fitting, these tests were performed only on the spectrum kernel, with n={3, 4, 5}. The results of this test were stable, with nearly identically strong results from 2⁻¹⁴ through 2⁻¹, using area above the ROC curve as the evaluation metric. In light of this, γ=0.001 was fixed as a middle-ground, and this value was used across all tests with kernels without further tuning.

The SpamAssassin public corpus is a database of spam and ham that has been widely used in the evaluation of spam filters. It contains roughly 6,000 total e-mail messages, with a 31% overall spam rate. A set of ten-fold cross validation experiments were run, using the 20030228 version of the corpus, choosing it because it was the largest contiguous data set. For the kernel methods, results for the spectrum kernel NGRAM with n=3, 4, 5, the full wildcard kernel FLWLD with (n,m)=(3, 1), (4, 1), and the fixed wildcard kernel FIXWLD with (n, p)=(3, 1), (4, 1), with binary scoring methods were reported. In addition, these kernels were tested with count-based scoring, which produced worse results, as count-based scoring is less resistant to the good word attack. Finally, these kernels were tested with other values of (n,m) and (n, p), with n ranging up to 6, and various positions p, with similar results not reported here.

For comparison, the same ten-fold cross validation tests were nm with SpamAssassin, SpamProbe, and Bogofilter. The evaluation metrics for all experiments were area above the ROC curve and precision at fixed recall levels 0.90, 0.95, and 0.99. These results are reported in Table 2. Results for SparnAssassin public corpus with tenfold cross validation. Precision reported for recall levels 0.90, 0.95, and 0.99. Area above the ROC curve is given in the last column. Results for all kernels are with binary scoring methods.

TABLE 2

| METHOD | .90 REC. | .95 REC. | .99 REC | 1-ROC |
|---|---|---|---|---|
| SPAMASSN | .996 | .993 | .955 | .0008 |
| SPAMPROBE | .999 | .998 | .972 | .0004 |
| BOGOFILTER | .999 | .998 | .986 | .0007 |
| NGRAM3 | .989 | .975 | .929 | .0024 |
| NGRAM4 | .992 | .975 | .932 | .0022 |
| NGRAM5 | .991 | .975 | .933 | .0022 |
| FLWLD(3, 1) | .999 | .997 | .992 | .0002 |
| FLWLD(4, 1) | .999 | .997 | .989 | .0002 |
| FIXWLD(3, 1) | .998 | .997 | .991 | .0002 |
| FIXWLD(4, 1) | 1.000 | .998 | .989 | .0002 |

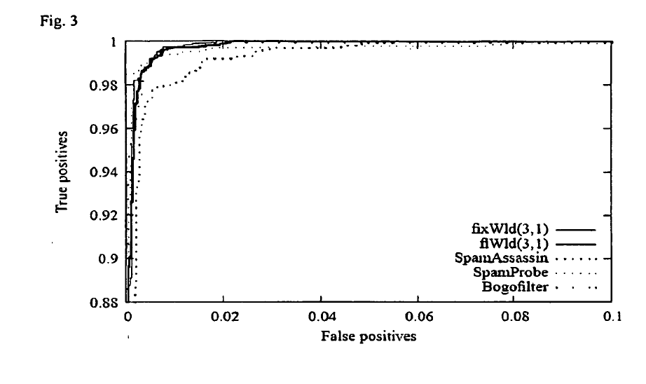

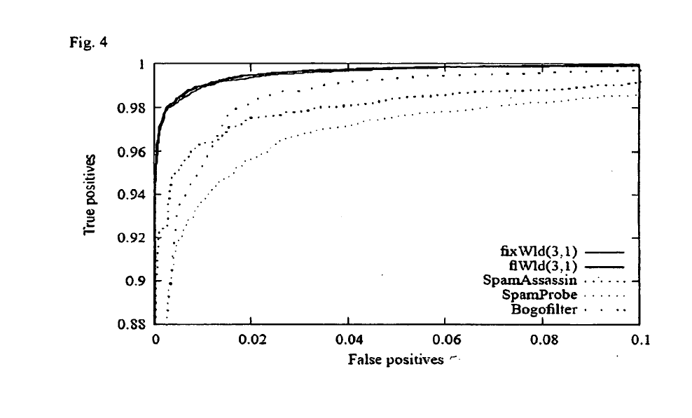

The ROC curves are for the open-source spam filters and the kernel methods are displayed for comparison in FIGS. 3 and 4, respectively. Note the vertical and horizontal axes of these plots were scaled to provide a more informative view of the critical top left corner of the curves, which ideally should be as close to that upper corner as possible.

The results of this test were encouraging. First, the wildcard kernels and fixed wildcard kernels solidly out-performed the n-gram spectrum kernels, especially at high levels of recall. This indicated that the strong results of the wildcard kernels were not unduly influenced by the addition of the RBF kernel—application of the spectrum kernel had the same advantage, and the RBF parameter γ was specifically tuned to the performance of the spectrum kernel. It was concluded that the better performance stems from the addition of the inexact matching enabled by wildcard characters. Secondly, while the performance of the binary and spectrum kernels and the count-scores spectrum kernels were almost identical, the binary wildcard and fixed wildcard kernels performed much better than the count-scored versions at all levels of recall.

The present invention is not limited to a particular mechanism. Indeed, an understanding of the mechanism is not necessary to practice the present invention. Nonetheless, it is contemplated that one possibility of why weighting provides even performance is that this provides some insurance against the good word attack, in which spammers try to defeat spamfilters by overloading their messages with words known to be highly representative of ham (see, e.g., D. Lowd and C. Meek. Good word attacks on statistical spam filters. In Proceedings of the Second Conference on Email and Anti-Spam (CEAS), 2005; herein incorporated by reference in its entirety), by ensuring that no one feature dominates the representation of the message at the outset.

In comparison with the open source spam filters, the wildcard and fixed wildcard kernel methods produced stronger precision results than SpamAssassin and SpamProbe at high recall levels, but while they also score more highly than BogoFilter, this difference is not as clearly pronounced. Furthermore, the difference in area above the ROC curve, while favoring the wildcard and fixed wildcard kernels, is not strictly conclusive. In order to confirm this difference, and to ensure that the superior performance of the wildcard and fixed wildcard kernels was not due to the happenstance of this particular data set, these results were validated with additional tests on the newly released TREC 2005 spam data set.

The TREC 2005 spam data set was compiled as a large benchmark data set for evaluating spam filters submitted to the TREC 2005 spam filtering competition (see, e.g., G. V. Cormack and T. R. Lynam. Spam corpus creation for TREC. In Proceedings of the Second Conference on Email and Anti-Spam (CEAS), 2005; G. V. Cormack and T. R. Lynam. TREC 2006 spam track overview. In The Fourteenth Text REtrieval Conference (TREC 2005) Proceedings, 2005; each herein incorporated by reference in their entireties). It has over 90,000 total e-mail messages and a 57% overall spam rate. Spam and ham were labeled in this data set with the assistance of human adjudication. The trec05p-1/full version of this data was used.

One peculiarity of the TREC spam competition is that it was designed as an on-line learning test—that is, algorithms were allowed to update and re-train after every test example. A batch testing methodology was employed, and trained and tested on fifteen independent batches of data drawn from this data set, in a manner similar to the more difficult delayed feedback test to be included in the 2006 TREC competition. However, efficient on-line learning is possible with incremental SVMs.

For repeatability, the exact construction of the train and test sets is described. The trec05p-1/full data set is partitioned into 308 directories, each of which contains roughly 300 messages. The first 300 of these directories were partitioned into sequential groups of twenty, using the messages in the first ten directories as training data, and the second ten as test data. Thus, each train/test set contained roughly 3000 training messages, and 3000 test messages, and each set was completely independent from other sets. The spam rate within sets varied considerably, mirroring real world settings where the future spam rate is unknown. The messages in the final eight directories were unused: users wishing to replicate this test may use these messages for parameter tuning and selection.

Because of the large scale of this experiment, the test to the open source spam filters, the (3,1) wildcard kernel, and the (3,1) fixed wildcard kernel were limited. For the wildcard kernels binary scoring in conjunction with the RBF kernel was used. As with the previous experiment, precision at several high recall levels was observed, as well as area above the ROC curve, which are given in Table 3.

TABLE 3

| METHOD | .90 REC. | .95 REC. | .99 REC | 1-ROC |
|---|---|---|---|---|
| SPAMPROBE | .962 | .939 | .842 | .0052 |
| SPAMASSN | .988 | .962 | .868 | .0030 |
| BOGOFILTER | .994 | .988 | .936 | .0021 |
| FIXWLD(3, 1) | .999 | .996 | .976 | .0005 |
| FLWLD(3, 1) | .999 | .996 | .979 | .0004 |

Table 3 presents large scale evaluation. Results for TREC 2005 spam data set, averaged over 15 independent train/test splits. Precision is reported for recall levels 0.90, 0.95, and 0.99. Area above the ROC curve is given in the last column. Results for all kernels are with binary scoring methods. The results were very favorable using the methods of the present invention.

The present invention is not limited to a particular mechanism. Indeed, an understanding of the mechanism is not necessary to practice the present invention. Nonetheless, it is contemplated that the results from these experiments give strong support to the use of wildcard kernels and SVM in spam classification, with both the wildcard kernel and the fixed wildcard kernel out-performing the open-source spam filters at high levels of recall. Results for area above the ROC curve are equally decisive. The greater distinction in performance between the wildcard kernels and the open source spam filters is attributed to, for example, the fact that the TREC 2005 data set is much larger than the SpamAssassin Public Corpus, and the TREC data contains more recent spam which reflects the advances in adversarial attacks used by contemporary spammers.

### Example II

This example describes the results of spam classification for the 2006 TREC Spam Filtering track utilizing the systems and methods of the present invention. The general approach was to map email messages to feature vectors, using the fixed (i, j, p) inexact string feature space. On-Line training and classification were performed using the PAM algorithm η was set to 0.1, and τ to 100.

As shown in Table 4, this filter configuration was tested at four settings.

TABLE 4

| FILTER | (i, j, p) | τ |
|---|---|---|
| TUFS1F | (2, 4, 1) | 100 |
| TUFS2F | (2, 5, 1) | 100 |
| TUFS3F | (2, 6, 1) | 100 |
| TUFS4F | (2, 7, 1) | 100 |

Each filter was given a unique setting of the maximum k-mer size, specified by j in the fixed (i, j, p) inexact string feature space. The value of τ=100 was chosen by parameter search, using the SpamAssassin public corpus as a tuning set. No preprocessing of the email messages was performed. The first n characters from the raw text of the email (including any header information and attachments) as an input string were used, and created a sparse feature vector from that string. The initial filters used a maximum of 200K characters, and performed successfully on initial tests for the trec05p-1 data set (see, e.g., Cormack and Lynam. Spam corpus creation for TREC. In Proceedings of the Second Conference on Email and Anti-Spam (CEAS), 2005; herein incorporated by reference in its entirety), and on all private data sets from the 2006 competition. However, two filters with larger maximum k-mer sizes failed to complete testing on the pe{i,d} data set due to lack of memory. When the maximum input string length from 200K to the first 3000 characters was reduced, this problem was eliminated—and performance for all filters improved. For example, on the pei| tests, TUFS1F| improved from 0.062 to 0.040 on (1-ROCA) % using the first 3000 characters. However, note that the official results for the 2006 competition were with TUFS filters using the first 200K characters.

For the initial tests, run before the 2006 competition, the filters were tested on the trec05p-1 data set, and found that the filters were competitive with the best filters from the TREC 2005 Spam Filtering track (see Table 5) (see, e.g., Cormack and Lynam. TREC 2006 spam track overview. In The Fourteenth Text Retrieval Conference (TREC 2005) Proceedings, 2005; herein incorporated by reference in its entirety). The results from the TREC 2006 competition were strong (see Table 5).

TABLE 5

| FILTER | PCI | PCD | PEI | PED | X2 | X2D | B2 | B2D | TREC05P-1 |
|---|---|---|---|---|---|---|---|---|---|
| BEST | 0.003 | 0.01 | 0.03 | 0.1 | 0.03 | 0.03 | 0.1 | 0.3 | 0.019 |
| TUFS1F | 0.002 | 0.008 | 0.060 | 0.211 | 0.095 | 0.199 | 0.390 | 0.836 | 0.020 |
| TUFS2F | 0.003 | 0.010 | 0.060 | 0.203 | 0.069 | 0.145 | 0.338 | 0.692 | 0.018 |
| TUFS3F | 0.004 | 0.012 | 0.042* | 0.132* | 0.063 | 0.126 | 0.335 | 0.614 | 0.018 |
| TUFS4F | 0.005 | 0.011 | 0.041* | 0.136* | 0.075 | 0.131 | 0.320 | 0.570 | 0.017 |
| MEDIAN | 0.03 | 0.3 | 0.3 | 0.3 | 0.1 | 0.1 | 0.3 | 1 | 0.4 |

Table 5 shows a summary of results on (1-ROCA) % measure. Results are reported for the tests on TREC 2006 public Chinese corpus pcd| and pcd|, public English corpus pei| ahnd ped, Mr. X private corpus x2 and x2d, b2 private corpus b2 and b2d, and the 2005 TREC public corpus trec05p-1. Results on sets ending in d are for delayed feedback experiments; others are for incremental learning experiments. Results marked with * were produced using variant that only considered first 3000 characters, rather than the first 200K.

In particular, the method achieved extremely strong performance on the public corpus of Chinese email, with a steep learning curve and a 1-ROCA score of 0.0023 for tufS1F, and 0.0031 for tufS2F on the incremental task, pci, which the initial report suggests are at or near the top level of performance for the 2006 competition, and are an order of magnitude better than the reported median. The results for the delayed learning task on Chinese email, pcd|, were also very strong.

In general, the results on other data sets were encouraging, giving second place aggregate results in the 2006 TREC spam competition. On the public English corpus, the methods gave results well above the median for both the incremental learning task pei| and the delayed learning task ped.

Overall, the fixed (i, j, p) inexact string features, represented as sparse explicit feature vectors, used in conjunction with the on-line linear classifier PAM has given strong performance on a number of tests. These results were obtained using inexact string matching without taking domain knowledge into account. It is expected that similar results will be observed with the use of inexact string matching on email specific features, such as the subject heading and sender information.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A method for identifying unwanted or harmful electronic text comprising: analyzing electronic text using an inexact string matching algorithm to identify unwanted or harmful text, if present in said electronic text, wherein said inexact string matching algorithm utilizes a database generated by machine learning method.

2. The method of claim 1, wherein said electronic text is contained in an electronic mail message.

3. The method of claim 1, wherein said electronic text is contained in an instant message.

4. The method of claim 1, wherein said electronic text is contained in a webpage.

5. The method of claim 1, wherein said inexact string matching algorithm is provided by a processor accessing a computer readable medium.

6. The method of claim 5, wherein said processor is provided on a computer.

7. The method of claim 5, wherein said processor is provided on a personal digital assistant.

8. The method of claim 5, wherein said processor is provided on a phone.

9. The method of claim 1, wherein said inexact string matching algorithm is provided by an electronic service provided over an electronic communication network.

10. The method of claim 1, wherein said inexact string matching algorithm is configured to analyze overlapping n-grams.

11. The method of claim 10, wherein said inexact string matching algorithm is configured to analyze overlapping n-grams comprising wildcard features.

12. The method of claim 11, wherein said wildcard features comprise fixed wildcard features.

13. The method of claim 10, wherein said inexact string matching algorithm is configured to analyze overlapping n-grams comprising mismatch features.

14. The method of claim 10, wherein said inexact string matching algorithm is configured to analyze overlapping n-grams comprising gappy features.

15. The method of claim 1, wherein said inexact string matching algorithm is configured to analyze a substring of text contained in said electronic text, wherein said substring is analyzed with and without gaps, wildcards, and mismatches.

16. The method of claim 1, wherein said inexact string matching algorithm is configured to analyze a sequence of features including one or more of n-grams, wildcard features, mismatch features, gappy features, substring features, repetition features, transposition features, transformation features, and at-a-distance features.

17. The method of claim 1, wherein said inexact string matching algorithm is configured to analyze a combination features including two or more of n-grams, wildcard features, mismatch features, gappy features, substring features, repetition features, transposition features, transformation features, and at-a-distance features.

18. The method of claim 1, wherein said inexact string matching algorithm is configured to analyze a number of features found in said electronic text or a substring of said electronic text, wherein said features are selected from the group consisting of: n-grams, wildcard features, mismatch features, gappy features, substring features, repetition features, transposition features, transformation features, and at-a-distance features.

19. The method of claim 1, wherein said inexact string matching algorithm is configured to analyze features found in said electronic text or a substring of said electronic text, wherein said features are selected from the group consisting of: n-grams, wildcard features, mismatch features, gappy features, substring features, repetition features, transposition features, transformation features, and at-a-distance features, and wherein said features are analyzed using a Kernel method to represent the features implicitly.

20. The method of claim 1, wherein said machine learning method is a supervised learning method.

21. The method of claim 20, wherein said supervised learning method is an on-line linear classifier.

22. The method of claim 21, wherein said on-line linear classifier is perceptron algorithm with margins.

23. The method of claim 1, wherein said machine learning method is an unsupervised learning method.

24. The method of claim 1, wherein said machine learning method is a semi-supervised learning method.

25. The method of claim 1, wherein said machine learning method is an active learning method.

26. The method of claim 1, wherein said machine learning method is an anomaly detection method.

27. The method of claim 1, wherein said machine learning method stores feature information in said database generated by said inexact string matching algorithm.

28. The method of claim 27, wherein said feature information is simplified prior to storage.

29. The method of claim 28, wherein said simplifying is conducted using a process selected from the group consisting of mutual information and principle component analysis.

30. The method of claim 27, wherein said feature information is transformed prior to storage in said database.

31. The method of claim 30, wherein said transforming is conducted using a process selected from the group consisting of rank approximation, latent semantic indexing, and smoothing.

32. The method of claim 1, wherein said unwanted or harmful electronic text is unwanted advertising.

33. The method of claim 1, wherein said unwanted or harmful electronic text is adult content.

34. The method of claim 1, wherein said unwanted or harmful electronic text is illegal content.

35. The method of claim 1, wherein said inexact string matching algorithm is configured to identify a feature using one or more of n-grams, wildcard features, mismatch features, gappy features, substring features, repetition features, transposition features, transformation features, and at-a-distance features, wherein a score is assigned based on a mathematical function associated with said features.

36. The method of claim 35, wherein said score is assigned based on a function depending on the number of times the features occur in said electronic text.

37. The method of claim 35, wherein said score is assigned based on a function depending on the existence of said features in said electronic text.

38. The method of claim 35, wherein said score is assigned based on a function depending on the relative frequency of the functions in said electronic text.

39. The method of claim 1, wherein said machine learning method utilizes said inexact string matching algorithm.

40. The method of claim 39, wherein said machine learning method utilizes said inexact string matching algorithm to explicitly generate features of said electronic text.

41. The method of claim 39, wherein said machine learning method utilizes said inexact string matching algorithm to implicitly generate features of said electronic text.

42. The method of claim 1, wherein said electronic text is contained in a larger electronic text document.

43. The method of claim 1, wherein said electronic text is transformed with an algorithm that edits the electronic text prior to using said inexact string matching algorithm.

44. The method of claim 1, further comprising the step of generating a score that indicates the level of harmfulness of said electronic text.

45. A system comprising a processor and a computer readable medium configured to carry out the method of claim 1.

46. A system comprising a computer readable medium encoding an algorithm configured to carry out the method of claim 1.
